(19) United States
(12) Patent Application Publication
(10) Pub. No.: US 2024/0416750 A1
(43) Pub. Date: Dec. 19, 2024

(54) VEHICLE SPEED DISPLAY DEVICE, VEHICLE SPEED DISPLAY METHOD, AND VEHICLE SPEED DISPLAY PROGRAM

(71) Applicants: TOYOTA JIDOSHA KABUSHIKI KAISHA, Toyota-shi Aichi-ken (JP); DENSO CORPORATION, Kariya-shi Aichi (JP)

(72) Inventors: Takahiro KAWANO, Chofu-shi Tokyo (JP); Toshifumi IWASE, Shinjuku-ku Tokyo (JP); Hisanobu INOUE, Tama-ku Kawasaki-shi Kanagawa (JP); Hironori ITO, Edogawa-ku Tokyo (JP)

(73) Assignees: TOYOTA JIDOSHA KABUSHIKI KAISHA, Toyota-shi Aichi-ken (JP); DENSO CORPORATION, Kariya-shi Aichi (JP)

(21) Appl. No.: 18/741,315

(22) Filed: Jun. 12, 2024

(30) Foreign Application Priority Data
Jun. 16, 2023 (JP) 2023-099432

(51) Int. Cl. B60K 35/21

(52) U.S. Cl. CPC B60K 35/213; B60K 2360/167; B60K 2360/175

(57) ABSTRACT

A vehicle speed display device is provided in a vehicle capable of executing vehicle control. The vehicle speed display device includes a first image generation unit configured to generate a first image indicating a vehicle speed of the vehicle and a display range of the vehicle speed; a second image generation unit configured to generate a second image indicating a vehicle speed range corresponding to a preset vehicle speed condition regarding the vehicle control; and a display control unit configured to display the first image and the second image on a display unit of the vehicle so that the second image is disposed along the first image.

### TECHNICAL FIELD

The present disclosure relates to a vehicle speed display device, a vehicle speed display method, and a vehicle speed display program.

### CROSS-REFERENCE TO RELATED APPLICATION

This application claims the benefit of priority from Japanese Patent Application No. 2023-099432, filed on Jun. 16, 2023, the entire contents of which are incorporated herein by reference.

### BACKGROUND

Japanese Patent Application Laid-Open No. 2018-118554 discloses a display device for vehicle that displays a set value of a traveling speed at which a host vehicle is traveling at the time of constant-speed cruising and a speed limit (regulatory speed) of a road on which the vehicle is traveling on a display unit.

Preset vehicle speed conditions regarding vehicle control including either driving assistance control or autonomous driving control are described in, for example, a vehicle owner's manual. However, remembering a vehicle speed range corresponding to vehicle speed conditions in advance may be a burden on the driver.

### SUMMARY

An aspect of the present disclosure is a vehicle speed display device provided in a vehicle capable of executing vehicle control, the vehicle speed display device includes a first image generation unit configured to generate a first image indicating a vehicle speed of the vehicle and a display range of the vehicle speed; a second image generation unit configured to generate a second image indicating a vehicle speed range corresponding to a preset vehicle speed condition regarding the vehicle control; and a display control unit configured to display the first image and the second image on a display unit of the vehicle so that the second image is disposed along the first image.

With the vehicle speed display device according to one aspect of the present disclosure, the second image is disposed along the first image on the display unit of the vehicle. Therefore, the driver can easily visually recognize the second image together with the first image. This makes it possible for the driver to easily recognize the vehicle speed range corresponding to the vehicle speed condition even when the vehicle is traveling. As a result, it is possible to reduce a burden of remembering the vehicle speed range corresponding to the vehicle speed condition in advance on the driver.

In one embodiment, the vehicle speed display device may include a surroundings situation acquisition unit configured to acquire a surroundings situation of the vehicle. The vehicle control may include one or more functional elements, the functional elements being functions that form elements constituting autonomous driving control. The vehicle speed range of the vehicle speed condition for a predetermined functional element may change depending on the surroundings situation. The second image generation unit may generate the second image by changing the vehicle speed range for the same functional element depending on the surroundings situation, based on the surroundings situation and the vehicle speed condition.

In one embodiment, the vehicle control may include one or more functional elements, the functional elements being functions that form elements constituting autonomous driving control. The second image may include a third image indicating the vehicle speed range in which a predetermined functional element is enabled during execution of the autonomous driving control, and a fourth image indicating the vehicle speed range in which a steering-non-holding state or a surroundings-non-checking state of a driver of the vehicle is allowed during execution of the autonomous driving control. The display control unit may display the third image and the fourth image on the display unit of the vehicle so that the third image is disposed on one side of the first image and the fourth image is disposed on the other side of the first image, with the first image interposed therebetween.

Another aspect of the present disclosure is a vehicle speed display method using a vehicle speed display device provided in a vehicle capable of executing vehicle control, the vehicle speed display method includes generating a first image indicating a vehicle speed of the vehicle and a display range of the vehicle speed; generating a second image indicating a vehicle speed range corresponding to a preset vehicle speed condition regarding the vehicle control; and displaying the first image and the second image on a display unit of the vehicle so that the second image is disposed along the first image.

With the vehicle speed display method according to another aspect of the present disclosure, the second image is disposed along the first image on the display unit of the vehicle. Therefore, the driver can easily visually recognize the second image together with the first image. This makes it possible for the driver to easily recognize the vehicle speed range corresponding to the vehicle speed condition even when the vehicle is traveling. As a result, it is possible to reduce a burden of remembering the vehicle speed range corresponding to the vehicle speed condition in advance on the driver.

Still another aspect of the present disclosure is a vehicle speed display program for causing a computer to function as a vehicle speed display device provided in a vehicle capable of executing vehicle control, the vehicle speed display program causing the computer to function as: a first image generation unit configured to generate a first image indicating a vehicle speed of the vehicle and a display range of the vehicle speed; a second image generation unit configured to generate a second image indicating a vehicle speed range corresponding to a preset vehicle speed condition regarding the vehicle control; and a display control unit configured to display the first image and the second image on a display unit of the vehicle so that the second image is disposed along the first image.

With the vehicle speed display program according to still another aspect of the present disclosure, the second image is disposed along the first image on the display unit of the vehicle. Therefore, the driver can easily visually recognize the second image together with the first image. This makes it possible for the driver to easily recognize the vehicle speed range corresponding to the vehicle speed condition even when the vehicle is traveling. As a result, it is possible to reduce a burden of remembering the vehicle speed range corresponding to the vehicle speed condition in advance on the driver.

According to some aspects of the present disclosure, it is possible to reduce a burden of remembering the vehicle speed range corresponding to the vehicle speed condition in advance on the driver.

### BRIEF DESCRIPTION OF THE DRAWINGS

FIG. 1 is a block diagram illustrating a vehicle including a vehicle speed display device according to an embodiment.

FIG. 2 is a diagram illustrating a first example of a first image and a second image displayed on a display unit.

FIG. 3 is a diagram illustrating a second example of the first image and the second image displayed on the display unit.

FIG. 4 is a diagram illustrating a third example of the first image and the second image displayed on the display unit.

FIG. 5 is a diagram illustrating a fourth example of the first image and the second image displayed on the display unit.

FIG. 6 is a diagram illustrating an example of a first image, and a second image including a third image and a fourth image displayed on the display unit.

FIG. 7 is a flowchart illustrating an example of vehicle speed display processing.

### DETAILED DESCRIPTION

Hereinafter, an embodiment of the present disclosure will be described with reference to the drawings. In the following description, the same or corresponding elements are denoted by the same reference signs, and redundant description thereof will be omitted.

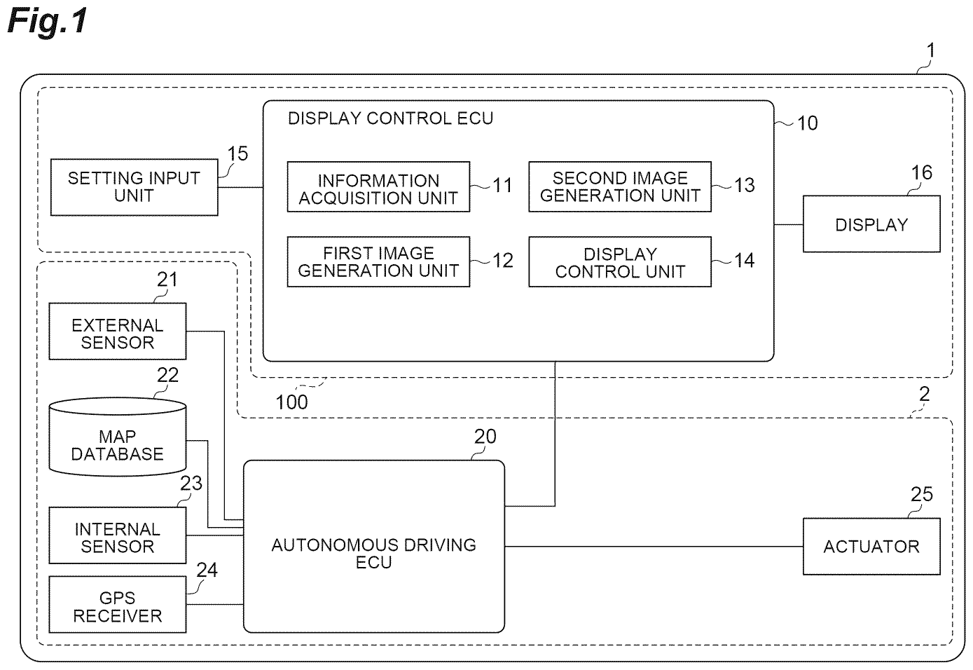

FIG. 1 is a block diagram illustrating a vehicle including a vehicle speed display device according to an embodiment. As shown in FIG. 1, a vehicle speed display device 100 is provided in a vehicle 1 capable of executing autonomous driving control (vehicle control). The vehicle 1 is, for example, a passenger car.

### [Configuration of Autonomous Driving System]

An autonomous driving system 2 is mounted on the vehicle 1. The autonomous driving system 2 is a system that executes the autonomous driving control of the vehicle 1. The autonomous driving control is vehicle control that causes the vehicle 1 to automatically travel along a road on which the vehicle 1 is traveling, without the driver performing any driving operation.

The autonomous driving control that can be executed by the vehicle 1 includes autonomous driving control that requires the driver to check surroundings. The autonomous driving control in which the driver is required to check the surroundings corresponds to autonomous driving control at an assistance level (less than level 3) in which the driver is responsible for driving. “The driver is required to check the surroundings” means that a surroundings-non-checking state is not allowed. The “surroundings-non-checking state” corresponds to a state in which the driver does not perform a predetermined surroundings-checking action (so-called eyes-off). The “surroundings-non-checking state” may be a state in which a face direction or line-of-sight direction of the driver is outside of a predetermined surroundings-checking range in excess of a predetermined time limit. The face direction or line-of-sight direction of the driver may be calculated, for example, based on a captured image of a driver monitor camera.

In autonomous driving control where the driver is required to check the surroundings, a temporary steering-non-holding state may be allowed for the driver of the vehicle 1. The “steering-non-holding state” means a state in which the driver is not performing a predetermined steering holding action (so-called hands-off). The “temporary steering-non-holding state” may be a state in which the driver does not hold a steering wheel of the vehicle 1 within a predetermined allowable time period. The holding of the steering wheel may be recognized based on a detection result of a touch sensor provided on the steering wheel of the vehicle 1, for example.

The autonomous driving control that can be executed by the vehicle 1 may include autonomous driving control that does not require the driver to check the surroundings. The autonomous driving control in which the driver is not required to check the surroundings corresponds to autonomous driving control at the assistance level (level 3 or higher) in which the driver is not responsible for driving. “The driver is not required to check the surroundings” means that so-called eyes-off is allowed. In the autonomous driving control at level 3 here, autonomous driving control that does not require the driver to check the surroundings may be executable only in a predetermined low vehicle speed range.

The autonomous driving system 2 includes an autonomous driving electronic control unit (ECU) 20, an external sensor 21, a map database 22, an internal sensor 23, a global positioning system (GPS) receiver 24, and an actuator 25.

The autonomous driving ECU 20 is an electronic control unit that includes a central processing unit (CPU), a read only memory (ROM), a random access memory (RAM), a controller area network (CAN) communication circuit, and the like. The autonomous driving ECU 20 controls hardware based on signals output from the CPU, and realizes functions of the autonomous driving ECU 20, which will be described later. As an example of a more specific operation, the autonomous driving ECU 20 operates a CAN communication circuit to input and output data, stores the input data in the RAM, loads a program stored in the ROM into the RAM, and executes the program loaded into the RAM. The autonomous driving ECU 20 may include a plurality of electronic units. Some of the functions of the autonomous driving ECU 20 may be executed by a server that can communicate with the vehicle 1.

The external sensor 21 includes at least one of a camera and a radar sensor. The camera is an imaging device that captures a surroundings situation of the vehicle 1. The camera is provided, for example, on the back side of a windshield of the vehicle 1, and images an area in the front of the vehicle. The radar sensor is a detection device that detects objects around the vehicle 1 using radio waves (for example, millimeter waves) or light. Examples of the radar sensor include radar (millimeter wave radar) or light detection and ranging (LiDAR). The external sensor 21 transmits the captured image and detection information regarding surrounding objects to the autonomous driving ECU 20.

The map database 22 is a database that stores map information. The map database 22 is formed in a recording device such as a hard disk drive (HDD) mounted on the vehicle 1, for example. The map information stored in the map database 22 includes, for example, position information of roads, shape information of the roads (for example, curvature information), and position information of intersections and branch points. The map information may include so-called high-accuracy map information in which the accuracy of road positions, road shapes, and the like is higher than that of a navigation map.

The internal sensor 23 is an in-vehicle sensor that detects a traveling state of the vehicle 1. The internal sensor 23 may include a vehicle speed sensor. The internal sensor 23 may include an acceleration sensor, and a yaw rate sensor. Known sensors can be used as the vehicle speed sensor, the acceleration sensor, and the yaw rate sensor. The internal sensor 23 transmits detection information regarding the traveling state of the vehicle 1 to the autonomous driving ECU 20.

The GPS receiver 24 measures a position of the vehicle 1 (for example, a latitude and longitude of the vehicle 1) by receiving signals from three or more GPS satellites. The GPS receiver 24 transmits measured position information of the vehicle 1 to the autonomous driving ECU 20.

The actuator 25 is a device that is used for control of traveling of the vehicle 1, and operates according to a control signal from the autonomous driving ECU 20. The actuator 25 includes at least a drive actuator, a brake actuator, and a steering actuator. The drive actuator is provided in, for example, an engine or a motor as a power supply, and controls a driving force of the vehicle 1. The brake actuator is provided, for example, in a hydraulic brake system and controls a braking force that is assigned to wheels of the vehicle 1. The steering actuator is, for example, an assistance motor of an electric power steering system, and controls a steering torque of the vehicle 1.

The autonomous driving ECU 20 is configured to be able to recognize the position of the vehicle 1 on the map, an external environment of the vehicle 1, and the traveling state of the vehicle 1.

The autonomous driving ECU 20 recognizes the external environment around the vehicle 1 based on detection information of the external sensor 21. The external environment includes a position of an object with respect to the vehicle 1, a relative speed of the object with respect to the vehicle 1, a moving direction of the object with respect to the vehicle 1, and the like. The object includes a moving object such as another vehicle around the vehicle 1 and a stationary object such as a structure around the vehicle 1. The external environment includes lane markings and a road shape recognized by lane marking recognition processing from the detection information of the external sensor 21.

The autonomous driving ECU 20 is configured to be able to acquire the map information that is used for vehicle control. The autonomous driving ECU 20 acquires the map information from the map database 22. The autonomous driving ECU 20 may acquire the map information from the server that can communicate with the vehicle 1 via a communication network.

The autonomous driving ECU 20 recognizes the traveling state of the vehicle 1 based on a detection result of the internal sensor 23. The traveling state includes, for example, a vehicle speed of the vehicle 1. The traveling state may include an acceleration of the vehicle 1, and a yaw rate of the vehicle 1.

The autonomous driving ECU 20 acquires the position of the vehicle 1 on the map based on position information of the GPS receiver 24 and the map information. The autonomous driving ECU 20 may recognize the position of the vehicle 1 on the map using a Simultaneous Localization and Mapping (SLAM) technology.

The autonomous driving ECU 20 generates a travel plan for the vehicle 1 based on the destination, the map information, the position of the vehicle 1 on the map, the external environment, and the traveling state (the vehicle speed, yaw rate, or the like). The destination may be a destination set by the occupant including the driver, or may be a destination proposed by the autonomous driving system 2.

The course of the vehicle 1 is a travel trajectory on which the traveling vehicle 1 is scheduled to travel in the future under autonomous driving control. The autonomous driving ECU 20 calculates a target route (route on a per-lane basis) for the vehicle 1 to the destination based on the destination, a current position of the vehicle 1 on the map, and the map information.

The autonomous driving ECU 20 calculates a speed pattern (speed plan) for the vehicle 1 to travel along the course. The autonomous driving ECU 20 calculates the speed pattern of the vehicle 1 based on the external environment such as a set speed for the autonomous driving control by the occupant, a speed limit (for example, a legal maximum speed) included in the map information, a temporary stop line included in the map information, position information of traffic lights or the like, preceding vehicles, pedestrians, and the like. The autonomous driving ECU 20 calculates the course and speed pattern of the vehicle 1 to generate a travel plan including the course and speed pattern of the vehicle 1.

The autonomous driving ECU 20 executes autonomous driving control of the vehicle 1 based on the generated travel plan. The autonomous driving ECU 20 transmits a control signal to the actuator 25 to control a vehicle speed and a steering angle of the vehicle 1 and execute autonomous driving control.

In the autonomous driving control of the autonomous driving ECU 20, one or more vehicle speed conditions are set in advance. The vehicle speed condition is a condition of a vehicle speed range regarding the autonomous driving control.

The vehicle speed condition includes a condition for a vehicle speed range enabling a predetermined functional element during execution of the autonomous driving control. The functional element is a function that forms an element constituting the autonomous driving control. The autonomous driving control includes one or more functional elements. The functional elements include, for example, at least one of traffic jam assistance, lane change assistance, and overtaking assistance. The functional elements may include at least one of lane tracing assistance, lane keep control, adaptive cruise control, radar cruise control, and pre-crash safety. The vehicle speed condition includes a condition of a first vehicle speed range for enabling automatic lane change (lane change assistance) during execution of the autonomous driving control. The vehicle speed condition includes a condition of a second vehicle speed range for enabling overtaking proposal (overtaking assistance) during execution of the autonomous driving control.

The vehicle speed condition includes a condition of a vehicle speed range for allowing the steering-non-holding state or the surroundings-non-checking state of the driver of the vehicle 1 during execution of the autonomous driving control. As an example, the vehicle speed condition includes a condition of a third vehicle speed range for temporarily allowing a steering-non-holding state (so-called hands-off) during execution of the autonomous driving control. The vehicle speed condition in the third vehicle speed range may be a condition during the autonomous driving control with the assistance level lower than level 3. The vehicle speed conditions include a condition of a fourth vehicle speed range for allowing the surroundings-non-checking state (so-called eyes-off) during execution of the autonomous driving control. The vehicle speed condition in the fourth vehicle speed range may be a condition during execution of autonomous driving control with the assistance level at level 3.

The vehicle speed condition may include a condition of a vehicle speed range under which the autonomous driving control itself is unavailable. As an example, the vehicle speed conditions include a condition of a fifth vehicle speed range under which the autonomous driving control itself is unavailable.

The autonomous driving ECU 20 determines whether the vehicle speed condition is satisfied based on the vehicle speed of the vehicle 1 and each vehicle speed condition. For example, when the vehicle speed of the vehicle 1 is included in the first vehicle speed range, the autonomous driving ECU 20 determines that the vehicle speed condition of the first vehicle speed range is satisfied, and enables the automatic lane change during execution of the autonomous driving control. When the vehicle speed of the vehicle 1 is included in the second vehicle speed range, the autonomous driving ECU 20 determines that the vehicle speed condition of the second vehicle speed range is satisfied, and enables the overtaking proposal during execution of the autonomous driving control. When the vehicle speed of the vehicle 1 is included in the third vehicle speed range during execution of the autonomous driving control at the assistance level lower than level 3, the autonomous driving ECU 20 determines that the vehicle speed condition of the third vehicle speed range is satisfied and allows a temporary steering-non-holding state. When the vehicle speed of the vehicle 1 is included in the fourth vehicle speed range during execution of the autonomous driving control at the assistance level being level 3, the autonomous driving ECU 20 determines that the vehicle speed condition of the fourth vehicle speed range is satisfied, and allows the surroundings-non-checking state. When the vehicle speed of the vehicle 1 is included in the fifth vehicle speed range, the autonomous driving ECU 20 determines that the vehicle speed condition of the fifth vehicle speed range is satisfied, and makes the autonomous driving control itself unavailable.

For the predetermined functional element, the vehicle speed range of the vehicle speed condition may change depending on the surroundings situation. The surroundings situation here includes, for example, a road shape of the road on which the vehicle 1 is traveling. As an example, in a vehicle speed condition for an automatic lane change during execution of the autonomous driving control, the first vehicle speed range may change depending on whether or not the vehicle 1 is traveling around a curve as the surroundings situation. In the vehicle speed condition for the overtaking proposal during execution of the autonomous driving control, the second vehicle speed range may change depending on whether or not the vehicle 1 is traveling around the curve as the surroundings situation. In the vehicle speed condition for whether or not the autonomous driving control itself can be used, the fifth vehicle speed range may change depending on whether or not the vehicle 1 is traveling around the curve as the surroundings situation. The surroundings situation is not limited to the road shape of the road on which the vehicle 1 is traveling.

### [Configuration of Vehicle Speed Display Device]

Next, a configuration of the vehicle speed display device 100 according to the present embodiment will be displayed. The vehicle speed display device 100 is a device that displays an image regarding the vehicle speed of the vehicle 1. The vehicle speed display device 100 mainly includes a display control ECU 10 mounted on the vehicle 1, a setting input unit 15, and a display (display unit) 16. The vehicle speed display device 100 may include an external sensor 21 for acquiring the surroundings situation of the vehicle 1, and an internal sensor 23 for acquiring the vehicle speed of the vehicle 1.

The display control ECU 10 is an electronic control unit (computer) that includes a CPU, a ROM, a RAM, a CAN communication circuit, and the like. The display control ECU 10 controls a display 16. The display control ECU 10 may be an electronic control unit built into the display 16. The display control ECU 10 may be a part of the autonomous driving ECU 20. The display control ECU 10 may include a plurality of electronic units. The display control ECU 10 is communicatively connected to, for example, the autonomous driving ECU 20. Some of functions of the display control ECU 10 may be executed by the server that can communicate with the vehicle 1.

The setting input unit 15 is a device that receives a setting input from the occupant of the vehicle 1. The setting input stands for an input of a setting for the image regarding the vehicle speed of the vehicle 1 to be displayed on the display 16. The setting input will be specifically described later.

As the setting input unit 15, for example, an input unit of a human machine interface (HMI) (for example, a touch panel display, buttons, or the like of a car navigation device) provided in the vehicle 1 can be used. The setting input unit 15 receives a setting input operation of the occupant. The setting input unit 15 transmits information on the received setting input from the occupant to the display control ECU 10.

The display 16 is a display device that is mounted on the vehicle 1 and displays an image to the driver. The image is displayed in a predetermined display area of the display 16. The display 16 is controlled by the display control ECU 10 and displays an image in the display area. A display device in which sizes of figures, shapes of the figures, luminance, colors, and the like can be changed is used as the display 16.

As an example of the display 16, a liquid crystal display (so-called multi-information display [MID]) provided in front of the driver on an instrument panel is used. In addition, a head up display (HUD), a liquid crystal display of a navigation system, or the like may be used as the display 16. The head-up display is a display device that projects an image from a projection unit installed in the instrument panel of the vehicle 1 onto a display surface of a front windshield (a reflective surface inside the front windshield).

Hereinafter, functions of the display control ECU 10 will be described. As shown in FIG. 1, the display control ECU 10 includes an information acquisition unit (surroundings situation acquisition unit) 11, a first image generation unit 12, a second image generation unit 13, and a display control unit 14 as functional configurations.

The information acquisition unit 11 acquires the vehicle speed of the vehicle 1 in order to display the vehicle speed on the display 16. The information acquisition unit 11 here can acquire the vehicle speed of the vehicle 1 using a recognition result of the autonomous driving ECU 20.

The information acquisition unit 11 acquires the surroundings situation of the vehicle 1. The surroundings situation includes, for example, the road shape of the road on which the vehicle 1 is traveling. The surroundings situation includes, for example, a situation indicating whether the road on which the vehicle 1 is traveling is a curve or a straight road. The information acquisition unit 11 may acquire the surroundings situation of the vehicle 1 based on the vehicle position of the vehicle 1 and the map information. The information acquisition unit 11 may acquire the surroundings situation of the vehicle 1 based on the external environment of the vehicle 1. The information acquisition unit 11 here can acquire the vehicle position of the vehicle 1, the map information, and the external environment using the recognition result of the autonomous driving ECU 20. The information acquisition unit 11 may determine that the vehicle 1 is traveling on a curve, for example, when the vehicle position of the vehicle 1 is within a range of the curve on the map. The information acquisition unit 11 may determine that the vehicle 1 is traveling on the curve, for example, when the lane markings and the road shape recognized by the lane marking recognition processing to be curves.

The first image generation unit 12 generates a first image indicating the vehicle speed of the vehicle 1 and a display range of the vehicle speed. The first image corresponds to a portion of the speedometer image of the vehicle 1 indicating a current speed of the vehicle 1. The vehicle speed display range is a predetermined speed range set in advance. The display range of the vehicle speed is, for example, a speed range of 0 km/h or more and 180 km/h or less.

The second image generation unit 13 generates a second image indicating the vehicle speed range corresponding to the vehicle speed condition. The second image corresponds to an image for juxtaposing whether or not a current vehicle speed of the vehicle 1 belongs to the vehicle speed range corresponding to the vehicle speed condition among the speedometer images of the vehicle 1. The second image generation unit 13 generates, as the second image, an image of the vehicle speed range corresponding to the vehicle speed condition applied at the current position on the map where the vehicle 1 is located. That is, the second image is equivalent to a vehicle speed range corresponding to a real-time vehicle speed condition.

The display control unit 14 displays the first image and the second image on the display 16 of the vehicle 1 so that the second image is disposed along the first image. The first image and the second image work together to indicate in which vehicle speed range a currently provided autonomous driving control function is available. The display control unit 14 may display the first image and the second image on the display 16 of the vehicle 1 so that the second image is disposed along the first image via another second image.

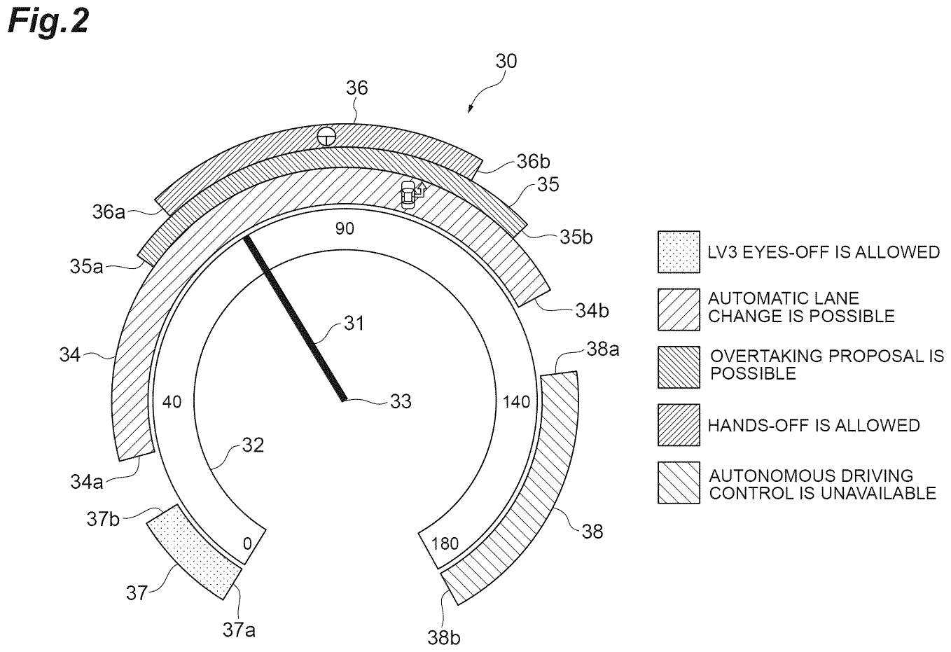

FIG. 2 is a diagram illustrating a first example of the first image and the second image displayed on the display unit. In FIG. 2, a speedometer image 30 of the vehicle 1 is illustrated. As shown in FIG. 2, the speedometer image 30 is an image of a speedometer of a type indicating the speed of the vehicle 1 at a tip of a needle 31.

The speedometer image 30 includes the needle 31 that rotates around a predetermined point 33, and an arc portion 32 centered on the point 33. The needle 31 is the first image indicating the vehicle speed of the vehicle 1. The arc portion 32 is a first image indicating the display vehicle speed range. The arc portion 32 has a band shape with a predetermined width extending along a circumferential direction of a circle centered on the point 33. The arc portion 32 does not extend under the point 33. The arc portion 32 has a C-shape that opens downward from the point 33. Inside the arc portion 32, a plurality of vehicle speed values included in the vehicle speed display range are shown as a guide for explanation. In the example of FIG. 2, the plurality of vehicle speed values are 0 km/h, 40 km/h, 90 km/h, 140 km/h, and 180 km/h. In the actual speedometer image 30, the vehicle speed values may be described in 10 km/h increments from 0 km/h to 180 km/h, for example.

In the example of FIG. 2, the second images are arc portions 34 to 38. The arc portion 34 is a second image indicating the first vehicle speed range regarding the automatic lane change described above. Inside the arc portion 34, an icon of the vehicle in a plan view indicating automatic lane change is drawn. The arc portion 34 has a band shape with a predetermined width that extends along the arc portion 32. The arc portion 34 and the arc portion 32 are disposed so that the vehicle speed values at adjacent positions are equal to each other. A low-speed side end portion 34a of the arc portion 34 is adjacent to the arc portion 32 at a position corresponding to a lower limit value of the first vehicle speed range. A high-speed side end portion 34b of the arc portion 34 is adjacent to the arc portion 32 at a position corresponding to an upper limit value of the first vehicle speed range. A width of the arc portion 34 may be equal to a width of the arc portion 32.

The arc portion 35 is a second image indicating the second vehicle speed range regarding the above-described overtaking proposal. The arc portion 35 has a band shape with a predetermined width that extends along the arc portion 32 via the arc portion 34. The arc portion 35, the arc portion 34, and the arc portion 32 are disposed so that the vehicle speed values at adjacent positions are equal to each other. A low-speed side end portion 35a of the arc portion 35 is adjacent to the arc portion 34 at a position corresponding to a lower limit value of the second vehicle speed range. A high-speed side end portion 35b of the arc portion 35 is adjacent to the arc portion 34 at a position corresponding to an upper limit value of the second vehicle speed range.

The width of the arc portion 35 is smaller than the width of the arc portion 34. That is, the width of the arc portion 34 located on the side close to the arc portion 32 may be larger than the width of the arc portion 35. The fact that the width of the arc portion 34 located on the side close to the arc portion 32 is larger than the width of the arc portion 35 means that the “automatic lane change” in the arc portion 34 is more important in the display to the driver than the “overtaking proposal” in the arc portion 35.

The low-speed side end portion 35a of the arc portion 35 is located on the higher vehicle speed side than the low-speed side end portion 34a of the arc portion 34. The high-speed side end portion 35b of the arc portion 35 is located on the lower vehicle speed side than the high-speed side end portion 34b of the arc portion 34. The arc portion 34 located close to the arc portion 32 has a longer circumferential extension length than the arc portion 35. A first vehicle speed range of the arc portion 34 located close to the arc portion 32 may be wider than a second vehicle speed range of the arc portion 35.

An arc portion 36 is a second image indicating the third vehicle speed range regarding the above-described temporary steering-non-holding state (hands-off). A steering wheel icon indicating the temporary steering-non-holding state is drawn inside the arc portion 36. The arc portion 36 has a band shape with a predetermined width that extends along the arc portion 32 via the arc portion 34 and the arc portion 35. The arc portion 36, the arc portion 34, the arc portion 35, and the arc portion 32 are disposed so that the vehicle speed values at adjacent positions are equal to each other. A low-speed side end portion 36a of the arc portion 36 is adjacent to the arc portion 35 at a position corresponding to a lower limit value of the third vehicle speed range. The high-speed side end portion 36b of the arc portion 36 is adjacent to the arc portion 35 at a position corresponding to the upper limit value of the third vehicle speed range.

The width of the arc portion 36 is equal to the width of the arc portion 35 and smaller than the width of the arc portion 34.

The low-speed side end portion 36a of the arc portion 36 is located on the higher vehicle speed side than the low-speed side end portion 35a of the arc portion 35. The high-speed side end portion 36b of the arc portion 36 is located on the lower vehicle speed side than the high-speed side end portion 35b of the arc portion 35. The arc portion 35 located close to the arc portion 32 has a longer circumferential extension length than the arc portion 36. The second vehicle speed range of the arc portion 35 located close to the arc portion 32 may be wider than the third vehicle speed range of the arc portion 36.

An arc portion 37 is a second image indicating the fourth vehicle speed range regarding the above-described surroundings-non-checking state (eyes-off). The arc portion 37 has a band shape with a predetermined width that extends along the arc portion 32. The arc portion 37 and the arc portion 32 are disposed so that the vehicle speed values at adjacent positions are equal to each other. A low-speed side end portion 37a of the arc portion 37 is adjacent to the arc portion 32 at a position corresponding to a lower limit value of the fourth vehicle speed range. A high-speed side end portion 37b of the arc portion 37 is adjacent to the arc portion 32 at a position corresponding to the upper limit value of the fourth vehicle speed range.

The high-speed side end portion 37b of the arc portion 37 is located on the lower vehicle speed side than the low-speed side end portion 34a of the arc portion 34. The arc portion 37 extends along the arc portion 32 on the lower vehicle speed side than the arc portion 34. A width of the arc portion 37 may be equal to the width of the arc portion 32.

The arc portion 38 is a second image indicating the fifth vehicle speed range regarding the unavailability of the above-described autonomous driving control itself. The arc portion 38 has a band shape with a predetermined width that extends along the arc portion 32. The arc portion 38 and the arc portion 32 are disposed so that the vehicle speed values at adjacent positions are equal to each other. A low-speed side end portion 38a of the arc portion 38 is adjacent to the arc portion 32 at a position corresponding to a lower limit value of the fifth vehicle speed range. A high-speed side end portion 38b of the arc portion 38 is adjacent to the arc portion 32 at a position corresponding to an upper limit value of the fifth vehicle speed range. The low-speed side end portion 38a of the arc portion 38 is located on the higher vehicle speed side than the high-speed side end portion 34b of the arc portion 34. The arc portion 38 extends along the arc portion 32 on the higher vehicle speed side than the arc portion 34. A width of the arc portion 38 may be equal to the width of the arc portion 32.

The second image generation unit 13 may generate the second image by changing the vehicle speed range for the same functional element depending on the surroundings situation based on the surroundings situation of the vehicle 1 and the vehicle speed condition. “Changing the vehicle speed range depending on the surroundings situation” means, for example, that the vehicle speed range of the vehicle speed condition for the same functional element can change depending on restrictions due to a road shape (for example, a curve), a topography (for example, a slope), weather (for example, rain or wind), VICS (registered trademark) information, or the like. The change in the vehicle speed range of the vehicle speed condition may be set in the autonomous driving ECU 20 in advance.

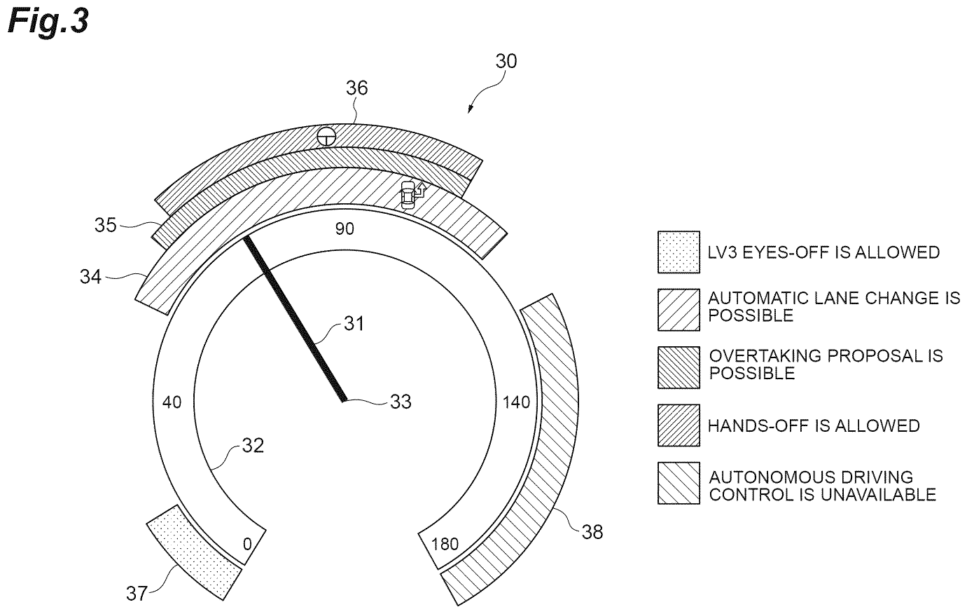

FIG. 3 is a diagram illustrating a second example of the first image and the second image displayed on the display unit. In FIG. 3, the speedometer image 30 of the vehicle 1, for example, in a case in which the vehicle 1 is traveling on the curve when the state of FIG. 2 is that the vehicle 1 is traveling on the straight road is illustrated. When the vehicle speed range of the vehicle speed condition changes depending on the surroundings situation of the vehicle 1, the vehicle speed range of the vehicle speed condition can change in real time, as shown in FIG. 3.

In the example of FIG. 3, the third vehicle speed range regarding the temporary steering-non-holding state (hands-off) and the fourth vehicle speed range regarding the surroundings-non-checking state (eyes-off) are not changed when the vehicle 1 is traveling on the straight road. The second image indicating the arc portion 36 and the second image indicating the arc portion 37 have not changed from FIG. 2.

The second vehicle speed range regarding the overtaking proposal has been changed compared to the second vehicle speed range when the vehicle 1 is traveling on the straight road. The upper limit value of the second vehicle speed range is made smaller to be equal to an upper limit value of a third vehicle speed range regarding hands-off. The lower limit value of the second vehicle speed range is increased to approach the lower limit value of the third vehicle speed range regarding hands-off. The second image indicating the arc portion 35 has changed from FIG. 2 according to change in the upper limit value and the lower limit value.

The first vehicle speed range regarding the automatic lane change has been changed compared to the second vehicle speed range when the vehicle 1 is traveling on the straight road. The upper limit value of the first vehicle speed range is made smaller to approach the upper limit value of the second vehicle speed range regarding the overtaking proposal. The lower limit value of the first vehicle speed range is made smaller to approach the lower limit value of the second vehicle speed range regarding the overtaking proposal. The second image indicating the arc portion 34 changes from FIG. 2 according to the change in the upper limit value and the lower limit value.

The fifth vehicle speed range regarding the unavailability of the autonomous driving control itself is changed compared to the second vehicle speed range when the vehicle 1 is traveling on the straight road. The upper limit value of the fifth vehicle speed range has not been changed when the vehicle 1 is traveling on the straight road. The lower limit value of the fifth vehicle speed range is made larger to approach the upper limit value of the first vehicle speed range regarding the automatic lane change. A second image indicating the arc portion 38 changes from FIG. 2 according to the change in the upper limit value and the lower limit value.

The second image generation unit 13 may determine the second image that is not to be displayed on the display 16 from among the plurality of second images, based on a setting input from the occupant of the vehicle 1 or setting pattern information stored in advance. The occupant of the vehicle 1 can arbitrarily customize the type of second image displayed on the display 16 through a setting input. The setting pattern information is pattern information in which whether or not to display the plurality of second images on the display 16 is set in advance depending on a degree of importance of the plurality of second images at the time of designing the vehicle speed display device 100.

The second image generation unit 13 may switch between display or non-display of the second image depending on the surroundings situation. The surroundings situation here may be, for example, weather or a current situation of other vehicles or the like around the vehicle 1. The second image generation unit 13 may change the degree of importance in displaying the second image to the driver depending on the surroundings situation. For example, when the weather is rainy, the second image generation unit 13 may change the degree of importance of the second image so that the arc portion 34 related to automatic lane change is displayed, and so that the arc portion 35 regarding the overtaking proposal and the arc portion 36 regarding the temporary steering-non-holding state (hands-off) are not displayed. The second image generation unit 13 may change the degree of importance of the second image so that the degree of importance of the second image is lowered and the arc portion 37 regarding the surroundings-non-checking state (eyes-off) is not displayed, for example, when the current situation around the vehicle 1 is that surroundings-checking cannot be omitted even when the vehicle 1 is at a low speed. The case in which surroundings-checking cannot be omitted may be, for example, a case in which the number of other vehicles is larger than a normal situation determined based on a past road situation, a case in which new other obstacles (such as road construction) are present, or the like. The degree of importance of the second image may be weighted depending on the surroundings situation. For example, even in the same case of the surroundings situation, the arc portion 36 regarding the temporary steering-non-holding state (hands-off) and the arc portion 37 regarding the surroundings-non-checking state (eyes-off) may be weighted with a greater weight than the arc portion 34 related to automatic lane change and the arc portion 35 regarding the overtaking proposal, and thus, may be easily set to the non-display on the display 16.

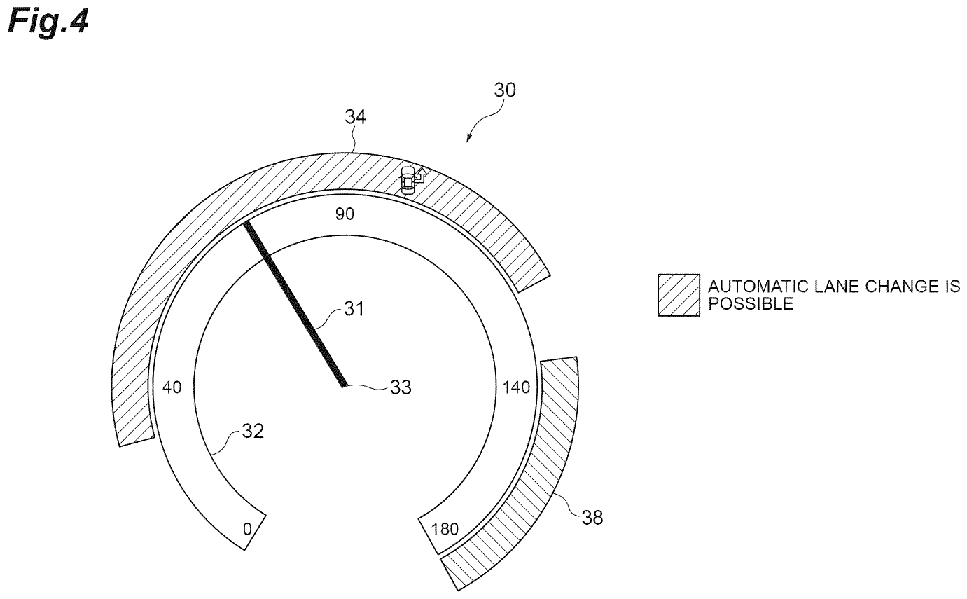

FIG. 4 is a diagram illustrating a third example of the first image and the second image displayed on the display unit. In FIG. 4, for example, the speedometer image 30 of the vehicle 1 in which the second image other than the arc portion 34 and the arc portion 38 is not displayed on the display 16 from the state shown in FIG. 2 is shown. In the example of FIG. 4, the second image other than the arc portion 34 and the arc portion 38 is set to the non-display, for example, in response to rainy weather or in response to a setting input from the occupant of the vehicle 1.

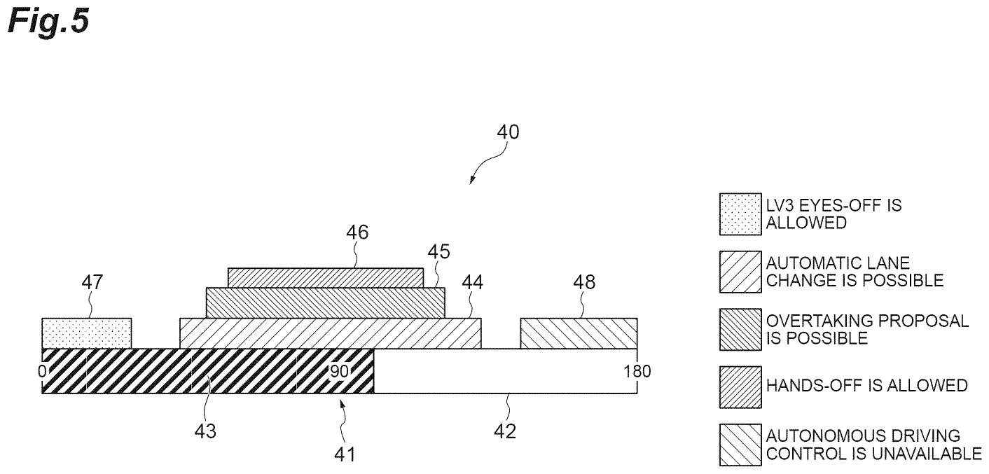

The first image generation unit 12 and the second image generation unit 13 may generate a speedometer image 40 in which the vehicle speed is carved linearly, unlike examples of circles shown in FIGS. 2 to 4 as the speedometer image 30. FIG. 5 is a diagram illustrating a fourth example of the first image and the second image displayed on the display unit. In FIG. 5, a bar graph 41 extending in a predetermined direction as a longitudinal direction is drawn. The predetermined direction may correspond to a vehicle width direction of the vehicle 1 in the display 16 installed in the vehicle 1, for example. As shown in FIG. 5, the bar graph 41 has an outer frame 42 and a value display 43. The outer frame 42 has a rectangular shape along the longitudinal direction. The value display 43 has a rectangular shape extending in the longitudinal direction, and is drawn within the outer frame 42 to be aligned to the left when viewed from the paper of the figure. The value display 43 may have a different color or pattern from that inside the outer frame 42, for example.

The outer frame 42 and the value display 43 are, for example, images indicating the vehicle speed with at a left end in the outer frame 42 as an origin, when viewed from the paper of the figure. A position within the outer frame 42 and a position of a right end of the value display 43 indicate higher vehicle speeds when the positions are located to the right as viewed from the page. A dimension in the longitudinal direction of the outer frame 42 represents the vehicle speed display range. The outer frame 42 and the value display 43 are first images indicating the vehicle speed and the display range of the vehicle speed.

Band portions 44 to 48 corresponding to the arc portions 34 to 38 are displayed side by side on an upper side of the outer frame 42 and the value display 43 when viewed from the paper of the figure. The band portion 44 is a second image indicating the first vehicle speed range regarding the above-described automatic lane change. The band portion 45 is a second image indicating the second vehicle speed range regarding the above-described overtaking proposal. The band portion 46 is the second image indicating the third vehicle speed range regarding the above-described temporary steering-non-holding state (hands-off). The band portion 47 is a second image indicating the fourth vehicle speed range regarding the above-described surroundings-non-checking state (eyes-off). The band portion 48 is a second image indicating the fifth vehicle speed range regarding the unavailability of the autonomous driving control itself described above. The display control unit 14 displays the outer frame 42, the value display 43, and the band portions 44 to 48 on the display 16 of the vehicle 1 so that the band portions 44 to 48 are disposed along the outer frame 42 and the value display 43.

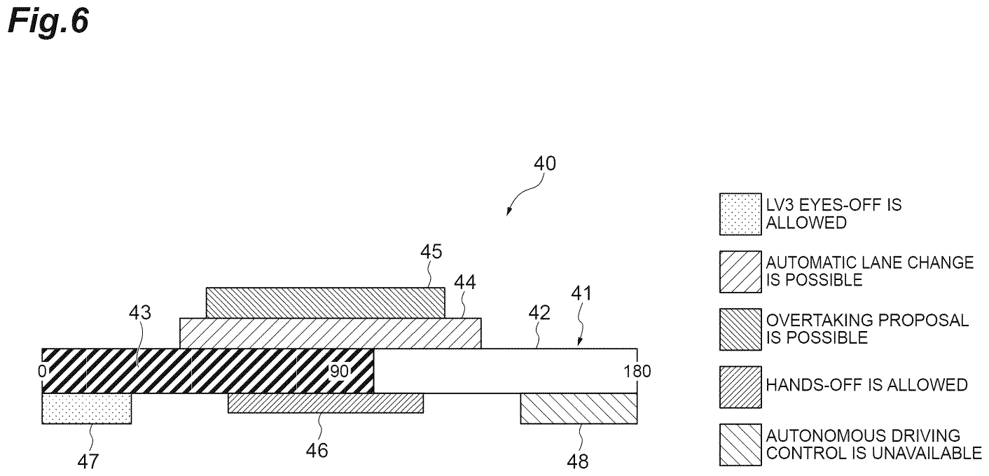

The second image includes a third image indicating a vehicle speed range in which a predetermined functional element is enabled during execution of the autonomous driving control, and a fourth image indicating a vehicle speed range in which the steering-non-holding state or the surroundings-non-checking state of the driver of the vehicle is allowed during execution of the autonomous driving control. The display control unit 14 displays the third image and the fourth image on the display 16 of the vehicle 1 so that the third image is disposed on one side of the first image and the fourth image is disposed on the other side of the first image, with the first image interposed therebetween. FIG. 6 is a diagram illustrating an example of a first image, and a second image including a third image and a fourth image displayed on the display unit.

In the example of FIG. 6, the band portion 44 is a third image indicating the vehicle speed range in which the automatic lane change is enabled during execution of the autonomous driving control. The band portion 45 is a third image indicating the vehicle speed range in which the overtaking proposal is enabled during execution of the autonomous driving control. The band portion 46 is a fourth image indicating the vehicle speed range in which the temporary steering-non-holding state (hands-off) of the driver of the vehicle 1 is allowed during execution of the autonomous driving control. The band portion 47 is a fourth image indicating the vehicle speed range in which the surroundings-non-checking state (eyes-off) of the driver of the vehicle 1 is allowed during execution of the autonomous driving control. The band portions 44 to 45 are displayed on one side (the upper side when viewed from the paper of the figure) of the outer frame 42 and the value display 43, making it easy for the driver of the vehicle 1 to recognize the vehicle speed range regarding an operation of the autonomous driving control. The band portions 46 to 48 are displayed on the other side (the lower side when viewed from the paper of the figure) of the outer frame 42 and the value display 43, making it easy for the driver of the vehicle 1 to recognize the vehicle speed range regarding a behavior and operation of the driver for the autonomous driving control.

### [Processing of Vehicle Speed Display Device, Vehicle Speed Display Method, and Processing of Vehicle Speed Display Program]

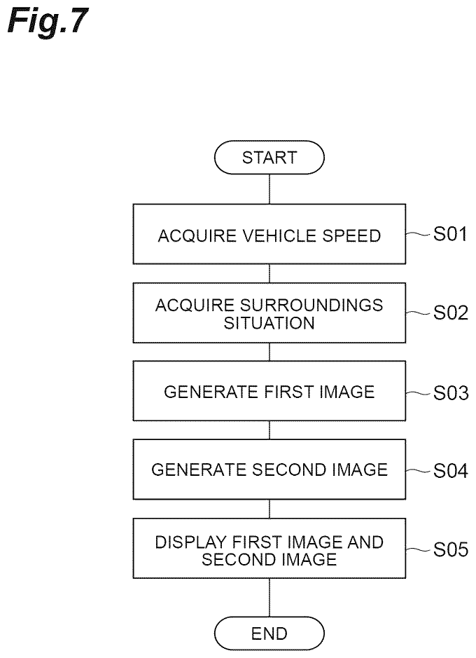

Next, an example of processing of the vehicle speed display device 100 will be described with reference to the flowchart in FIG. 7. FIG. 7 is a flowchart illustrating an example of vehicle speed display processing (vehicle speed display method). The processing (steps) shown in FIG. 7 are repeatedly executed at every predetermined calculation cycle, for example, when a main power supply of the vehicle 1 is turned on.

As shown in FIG. 7, the display control ECU 10 of the vehicle speed display device 100 acquires the vehicle speed using the information acquisition unit 11 in S01. The information acquisition unit 11 acquires the vehicle speed of the vehicle 1, for example, using the recognition result of the autonomous driving ECU 20 based on the detection result of the internal sensor 23.

In S02, the display control ECU 10 uses the information acquisition unit 11 to acquire the surroundings situation. The information acquisition unit 11 acquires the surroundings situation of the vehicle 1 based on the vehicle position of the vehicle 1 and the map information, for example. The information acquisition unit 11 may acquire the surroundings situation of the vehicle 1 based on the external environment of the vehicle 1. The information acquisition unit 11 can use, for example, the detection result of the external sensor 21, the map information of the map database 22, and the recognition result of the autonomous driving ECU 20 based on the reception result of the GPS receiver 24 to acquire the vehicle position of the vehicle 1, the map information, and the external environment.

In S03, the display control ECU 10 uses the first image generation unit 12 to generate the first image. The first image generation unit 12 generates an image of a portion of the speedometer image of the vehicle 1 indicating the current speed of the vehicle 1. The first image generation unit 12 generates the speedometer image 30 that has the needle 31 rotating around the predetermined point 33 and the arc portion 32 centered on the point 33, as shown in FIGS. 2 to 4, for example. The first image generation unit 12 may generate the speedometer image 40 as a bar graph 41 having an outer frame 42 and a value display 43, as shown in FIGS. 5 and 6, for example.

In S04, the display control ECU 10 uses the second image generation unit 13 to generate the second image. The second image generation unit 13 acquires the vehicle speed condition, and generates the image for juxtaposing whether or not a current vehicle speed of the vehicle 1 belongs to the vehicle speed range corresponding to the vehicle speed condition among the speedometer images of the vehicle 1. The second image generation unit 13 generates the arc portions 34 to 38 as shown in FIG. 2, for example. The second image generation unit 13 may generate the second image by changing the vehicle speed range for the same functional element depending on the surroundings situation, based on the surroundings situation of the vehicle 1 and the vehicle speed condition, for example, as shown in FIG. 3. The second image generation unit 13 may switch between a display and a non-display of the second image depending on the surroundings situation, as shown in FIG. 4, for example. The second image generation unit 13 may determine the second image that is not to be displayed on the display 16 from among the plurality of second images, based on a setting input from the occupant of the vehicle 1 or setting pattern information stored in advance. The second image generation unit 13 may generate the band portions 44 to 48 as shown in FIGS. 5 and 6, for example.

In S05, the display control ECU 10 uses the display control unit 14 to display the first image and the second image. The display control unit 14 displays the first image and the second image on the display 16 of the vehicle 1 so that the second image is disposed along the first image, as shown in FIGS. 2 to 5, for example. The display control unit 14 may display the third image and the fourth image on the display 16 of the vehicle 1 so that the third image is disposed on one side of the first image and the fourth image is disposed on the other side of the first image, with the first image interposed therebetween, for example, as shown in FIG. 6. Thereafter, the display control ECU 10 ends the processing of FIG. 7.

### [Vehicle Speed Display Program]

The vehicle speed display program causes the display control ECU 10 to function (operate) as the information acquisition unit 11, the first image generation unit 12, the second image generation unit 13, and the display control unit 14 described above. The vehicle speed display program is provided, for example, by a non-temporary recording medium such as a ROM or a semiconductor memory. The vehicle speed display program may be provided through communication using a network.

According to the vehicle speed display device 100, the vehicle speed display method, and the vehicle speed display program described above, the driver can easily visually recognize the second image along with the first image, since the second image is disposed along the first image on the display 16 of the vehicle 1. This makes it possible for the driver to easily recognize the vehicle speed range corresponding to the vehicle speed condition even when the vehicle 1 is traveling. As a result, it is possible to reduce a burden of remembering the vehicle speed range corresponding to the vehicle speed condition in advance on the driver.

In the vehicle speed display device 100, the vehicle speed display method, and the vehicle speed display program, the surroundings situation of the vehicle 1 is acquired. The autonomous driving control includes one or more functional elements that are functions that form elements constituting the autonomous driving control. In the vehicle speed condition for a predetermined functional element, the vehicle speed range changes depending on the surroundings situation. The second image is generated so that the vehicle speed range for the same functional element is changed depending on the surroundings situation, based on the surroundings situation and the vehicle speed condition. Accordingly, the driver can recognize changes in the vehicle speed range corresponding to the vehicle speed condition even when the vehicle 1 is traveling, since the second image changes to indicate the vehicle speed range depending on the surroundings situation.

In the vehicle speed display device 100, the vehicle speed display method, and the vehicle speed display program, the autonomous driving control includes one or more functional elements that are functions that form the elements constituting the autonomous driving control. The second image includes the third image indicating a vehicle speed range in which a predetermined functional element is enabled during execution of the autonomous driving control, and a fourth image indicating a vehicle speed range in which the steering-non-holding state or the surroundings-non-checking state of the driver of the vehicle 1 is allowed during execution of the autonomous driving control. The third image and the fourth image are displayed on the display 16 of the vehicle 1 so that the third image is disposed on one side of the first image and the fourth image is disposed on the other side of the first image, with the first image interposed therebetween. Accordingly, part or all of the second image is divided into a third image and a fourth image, with the first image interposed therebetween and displayed. This makes it possible to curb the driver confusing the second vehicle speed range represented by the third image and the second vehicle speed range represented by the fourth image in the second image.

The driver can, for example, adjust the vehicle speed of the vehicle 1 manually to satisfy the vehicle speed condition of the functional element that the driver wants to use, by viewing the second image together with the first image. For example, when the driver does not ascertain the functional elements provided depending on the speed range, the driver may experience inconveniences such as the driver being unable to use autonomous driving by setting the vehicle speed to be too high or being unable to use automatic lane change on a curve or the like. According to the vehicle speed display device 100, the vehicle speed display method, and the vehicle speed display program, since the driver can visually check the functional elements provided depending on the speed range, it is possible for the driver to take measures the set vehicle speed manually such as not to be too high when wanting to use the hands-off.

Although the embodiments of the present disclosure have been described above, the present disclosure is not limited to the above embodiments.

In the embodiment, the second image is generated to change the vehicle speed range for the same functional element depending on the surroundings situation, but this example may be omitted. The vehicle speed range may not be changed depending on the surroundings situation. In this case, the processing of S02 in FIG. 7 may be omitted.

In the embodiment, FIGS. 2 to 6 are illustrated as speedometer images, but the present disclosure is not limited thereto. The second image of other functional elements may also be included. The first image and the second image may be generated as a shape other than an arc shape or a linear shape.

FIG. 3 has illustrated an example where the road shape is a curve as the surroundings situation of the vehicle 1, but the present disclosure is not limited to this example. The surroundings situation may be, for example, restrictions based on the topography, the weather, the VICS information, or the like. In a linear speedometer image 40 of FIGS. 5 and 6, the second image may be generated to change the vehicle speed range depending on the surroundings situation.

Although FIG. 4 is an example in which the surroundings situation of the vehicle 1 is weather and a current situation of, for example, other vehicles around the vehicle 1, the present disclosure is not limited to this example. The surroundings situation may be, for example, the restrictions based on the road shape, the topography, VICS information, or the like. In the linear speedometer image 40 of FIGS. 5 and 6, the display or non-display of the second image may be switched depending on the surroundings situation.

Although the vehicle speed display device 100 is provided in the vehicle 1 that can execute the autonomous driving control in the embodiment, the vehicle speed display device 100 may also be provided in a vehicle that can execute the driving assistance control. The driving assistance control is control for assisting in a driving operation of the driver. The driving assistance control may be a function (for example, adaptive cruise control) corresponding to any of the above-described functional elements.

What is claimed is:

1. A vehicle speed display device provided in a vehicle capable of executing vehicle control, the vehicle speed display device comprising:
a first image generation unit configured to generate a first image indicating a vehicle speed of the vehicle and a display range of the vehicle speed;
a second image generation unit configured to generate a second image indicating a vehicle speed range corresponding to a preset vehicle speed condition regarding the vehicle control; and
a display control unit configured to display the first image and the second image on a display unit of the vehicle so that the second image is disposed along the first image.

2. The vehicle speed display device according to claim 1, comprising:
a surroundings situation acquisition unit configured to acquire a surroundings situation of the vehicle, wherein
the vehicle control includes one or more functional elements, the functional elements being functions that form elements constituting autonomous driving control,
the vehicle speed range of the vehicle speed condition for a predetermined functional element changes depending on the surroundings situation, and
the second image generation unit generates the second image by changing the vehicle speed range for the same functional element depending on the surroundings situation, based on the surroundings situation and the vehicle speed condition.

3. The vehicle speed display device according to claim 1, wherein:
the vehicle control includes one or more functional elements, the functional elements being functions that form elements constituting autonomous driving control,
the second image includes a third image indicating the vehicle speed range in which a predetermined functional element is enabled during execution of the autonomous driving control, and a fourth image indicating the vehicle speed range in which a steering-non-holding state or a surroundings-non-checking state of a driver of the vehicle is allowed during execution of the autonomous driving control, and
the display control unit displays the third image and the fourth image on the display unit of the vehicle so that the third image is disposed on one side of the first image and the fourth image is disposed on the other side of the first image, with the first image interposed therebetween.

4. The vehicle speed display device according to claim 2, wherein:
the vehicle control includes one or more functional elements, the functional elements being functions that form elements constituting autonomous driving control,
the second image includes a third image indicating the vehicle speed range in which a predetermined functional element is enabled during execution of the autonomous driving control, and a fourth image indicating the vehicle speed range in which a steering-non-holding state or a surroundings-non-checking state of a driver of the vehicle is allowed during execution of the autonomous driving control, and
the display control unit displays the third image and the fourth image on the display unit of the vehicle so that the third image is disposed on one side of the first image and the fourth image is disposed on the other side of the first image, with the first image interposed therebetween.

5. A vehicle speed display method using a vehicle speed display device provided in a vehicle capable of executing vehicle control, the vehicle speed display method comprising:
generating a first image indicating a vehicle speed of the vehicle and a display range of the vehicle speed;
generating a second image indicating a vehicle speed range corresponding to a preset vehicle speed condition regarding the vehicle control; and
displaying the first image and the second image on a display unit of the vehicle so that the second image is disposed along the first image.

6. A vehicle speed display program for causing a computer to function as a vehicle speed display device provided in a vehicle capable of executing vehicle control, the vehicle speed display program causing the computer to function as:
a first image generation unit configured to generate a first image indicating a vehicle speed of the vehicle and a display range of the vehicle speed;
a second image generation unit configured to generate a second image indicating a vehicle speed range corresponding to a preset vehicle speed condition regarding the vehicle control; and
a display control unit configured to display the first image and the second image on a display unit of the vehicle so that the second image is disposed along the first image.
